(19) United States
(12) Patent Application Publication
(10) Pub. No.: US 2009/0145738 A1
(43) Pub. Date: Jun. 11, 2009

(54) Mass Exchange Contact Device

(76) Inventors: Bogdan Vladimirovich Maleta, Kiev Region (UA); Olesja Vladimirovna Maleta, Kiev Region (UA)

Correspondence Address: Aleksandr Smushkovich, POB 140505, Brooklyn, NY, 11214, US

(21) Appl. No.: 12/225,575

(22) PCT Filed: Apr. 3, 2007
(86) PCT No.: PCT/UA2007/000021

§ 371 Date: Sep. 24, 2008

(30) Foreign Application Priority Data
Apr. 10, 2006 (UA) A 2006 03889

(51) Int. Cl. B01D 3/20; B01D 3/30

(52) U.S. Cl. 202/258

(57) ABSTRACT

A mass-exchange contact device is proposed, comprising: upper and lower trays, a contact element including a barbotage unit, a cylindrical casing including windows circumferentially disposed thereon and orifices circumferentially disposed above the windows, a movable valve including two solid plates one above the other and attached to a distance rod, and a cover bushing disposed around the upper region of casing. The contact element restricts the valve's upward movement, the casing's bottom edge restricts the valve's downward movement, the bottom edges of the windows are disposed at the level of lower tray, and the exterior of contact element communicates with the interior of casing via the inner space of the bushing and the orifices. In some embodiments, the windows and orifices are united in continuous openings. The device significantly improves operation especially for a cyclic mode, reliability, and durability.

### CROSS-REFERENCE TO RELATED APPLICATIONS

This application is a U.S. national phase application of a PCT application PCT/UA2007/000021 filed on 3 Apr. 2007, published as WO2007/117227, whose disclosure is incorporated herein in its entirety by reference, which PCT application claims priority of a Ukrainian patent application UA2006/03889 filed on 10 Apr. 2006, now Patent of Ukraine No 281700.

### FIELD OF THE INVENTION

The invention relates to mass exchange contact devices, namely to the devices used for performing mass exchange processes in a gas (steam)—fluid system in the conditions of cyclic mode (at the separate movement of phases in a column) and can be used in the food, chemical, petrochemical, oil-processing and other industries.

### BACKGROUND OT THE INVENTION

There is known a mass exchange contact device comprising a plate face with contact elements. The plate face includes ring-shaped holes with cross-pieces, which holes are disposed along the periphery of the contact elements. A central hole is disposed under the contact element, a branch pipe and a ring are mounted on the axe of central hole. The ring is equipped with a movable double-acting valve arranged in the middle thereof. The valve is made of plates with central holes, wherein the plates are connected by means of distance poles. The upper hole is used for passing the branch pipe. An interrupting valve is mounted on a rod situated between limiters of ascending and descending under the lower hole (USSR inventor certificate No 1307643).

The disadvantages of this device are: it's composed of a plurality (two) of movable parts; there is a restriction of the opening cross-section of branch pipe for passing gas (steam), as well as a restriction of the ringed holes' opening cross-section for a liquid flow.—These disadvantages increase the plate's hydraulic resistance at the time of gas (steam) passing, and the time of transferring liquid from one plate to another.

There is known a mass exchange contact device, which has a plate board with a contact element, a ring, a movable double-acting valve, lifting and descending limiters. The ring has holes along the perimeter, and the movable valve is performed as plates installed above one another. The device is equipped with an additional plate board.

The contact element serves as a lifting limiter for the double-acting valve and the bottom edge of the ring serves as a descending limiter. The lower edges of the ring holes are made at the level of additional (bottom) plate board. Besides, the contact element is made in the form of inner cap with tangently bent boards of a barbotage unit, the height of vertical holes along the ring perimeter equals the height of double-acting valve, and in the ending positions of the double-acting valve, one valve board divides the free opening of vertical ring holes into equal sectors (RU 2237508 C1).

The disadvantage of this device is the shifting of the device working range to the side of increasing the steam volumetric expenditure under large liquid loads A spontaneous plate unloading happens due to a descending of the valve at the period of steam supply caused by presence of a great amount of liquid in the plate during insufficient steam expenditure, which creates not optimal operation conditions of the device for a cyclic mode. By increasing the steam expenditure, one worsens the conditions of pouring out the liquid from a transit vessel into the plate situated below up to the complete locking of the column.

### BRIEF DESCRIPTION OF THE INVENTION

The primary aim of the present invention is the improvement of known mass exchange contact devices, namely, the providing of optimal conditions for operating such a device in the cyclic mode of mass exchange processes, the extension of the load operating range with respect to liquid and steam, the reduction of influence of a delay of gas (steam) flow pressure pulses along the column's height due to autonomic activity of every contact device at the separate phase movement, the increasing of efficiency, reliability, and durability of the device. Other aims of the invention may become apparent to a skilled artisan upon learning the present disclosure.

The mentioned problems are solved by providing a special design of the inventive mass exchange contact device comprising an upper tray; a contact element coupled to the upper tray, which contact element including a barbotage unit configured as an inner cap with strips tangently bent out; an additional lower tray disposed substantially in a parallel plane below the upper tray; a cylindrical casing including a plurality of vertically extended windows circumferentially disposed on the vertical walls of the casing (lower row) and a plurality of circular orifices circumferentially disposed on the walls of the casing (upper row) above the windows; a movable double-acting (bi-directional) valve composed of two solid plates disposed one above the other and fixedly attached to a distance rod situated at the central axe of the valve; and a cover bushing disposed coaxially around the casing; wherein: the contact element also functions as a limiter for lifting the valve i.e. restricting the upward movement of the valve, whereas the bottom edge of the casing functions as a limiter for lowering the valve i.e. restricting the downward movement of the valve, the bottom edges of the windows are disposed at the level of the lower tray, and the exterior of the contact element is communicated with the interior of the casing via the inner space of the bushing and via the orifices.

The aforesaid features effect the following results:

1) The lifting force exerted on the valve during its upward movement increases due to the maximal possible pressure difference applied to the upper plate of the valve, as gas (steam) doesn't penetrate into the space over the upper plate.

2) During the passing of gas (steam) to the contact element over the upper plate of the valve through the row of orifices and the bushing's interior, the dynamic thrust of the steam flow is deployed as an additional force, for support of the valve in the upper position.

3) At a reducing or fluctuation of the gas (steam) expenditure for a fixed opening cross-section of the contact element for passing gas (steam) (for example 10%), meaning a decrease of pressure difference at the plate, the valve descends to the level of orifices row thereby creating a situational free cross-section for the flow of gas (steam) with a lower value (e.g. 2%), but still sufficient for support of the valve in the upper position due to stabilization of the pressure difference applied to the plate

4) At a smooth closing of the gas (steam) flow, the valve, moving downwards, reduces the speed of its movement at the level of orifices row, and mildly, without an impact, touches the lower limiter (the bottom edge of the casing), thereby extending durability of the valve.

### DESCRIPTION OF DRAWINGS OF THE INVENTION

The invention is illustrated in the following drawings:

FIG. 1 is a view showing the mass exchange contact device at an initial moment of supplying gas (steam) according to a preferred embodiment of the present invention;

FIG. 2 is a view showing the device in at the moment of altering the exertion of lifting force from the lower plate to the upper plate of the valve, according to the preferred embodiment of the present invention;

FIG. 3 is a view showing the mass exchange contact device at a position corresponding the subsequent moments of supplying gas (steam) according to the preferred embodiment of the present invention;

FIG. 4 is a view showing the mass exchange contact device at a position for creation of free situational cross-section for passing gas (steam), according to the preferred embodiment of the present invention;

FIG. 5 is a plan sectional view from above of the inventive device, according to the preferred embodiment of the present invention;

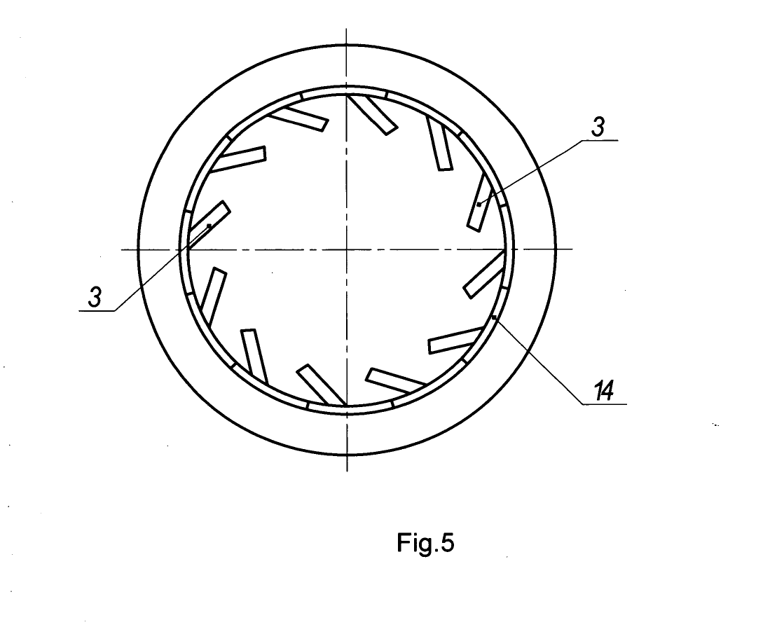

Each reference numeral indicated on the drawings is designated to an element of the inventive structure described herein below. A first time introduced reference numeral in the description is enclosed into parentheses.

### DETAIL DESCRIPTION OF THE PREFERRED EMBODIMENT

While the invention may be susceptible to embodiment in different forms, there are described in detail herein below, specific embodiments of the present invention, with the understanding that the present disclosure is to be considered an exemplification of the principles of the invention, and is not intended to limit the invention to that as illustrated and described herein.

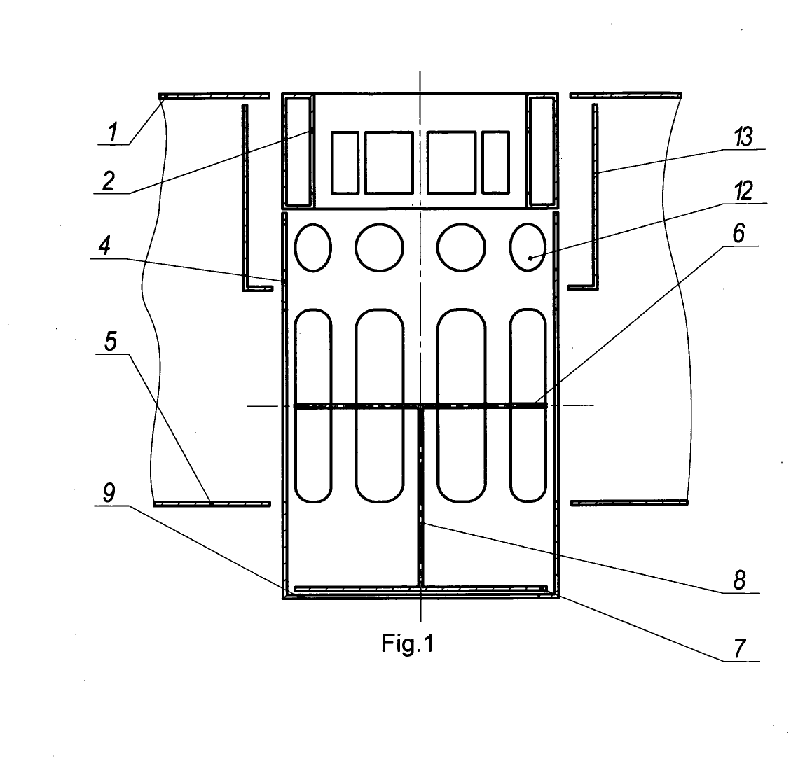

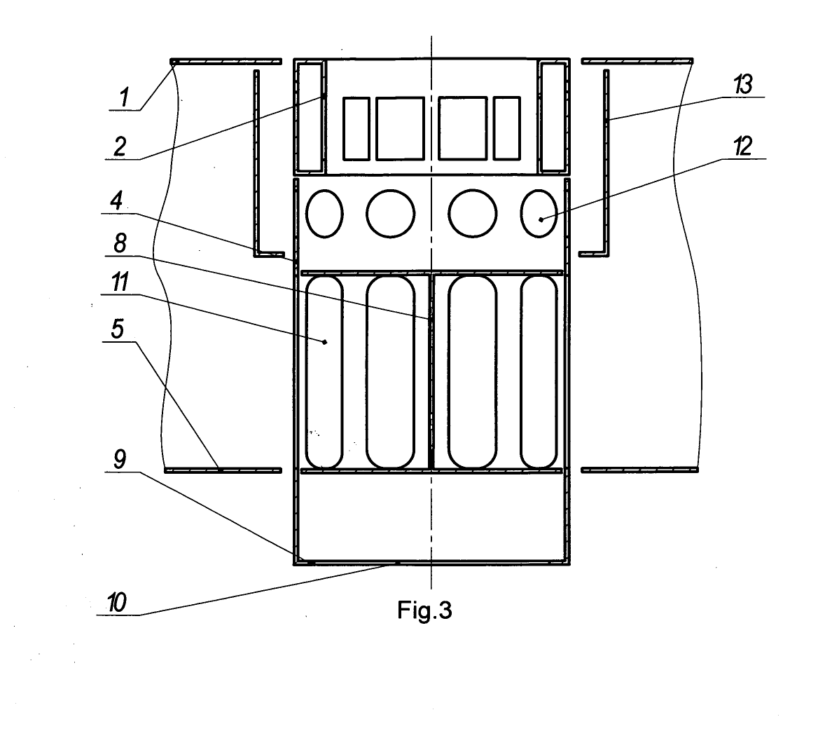

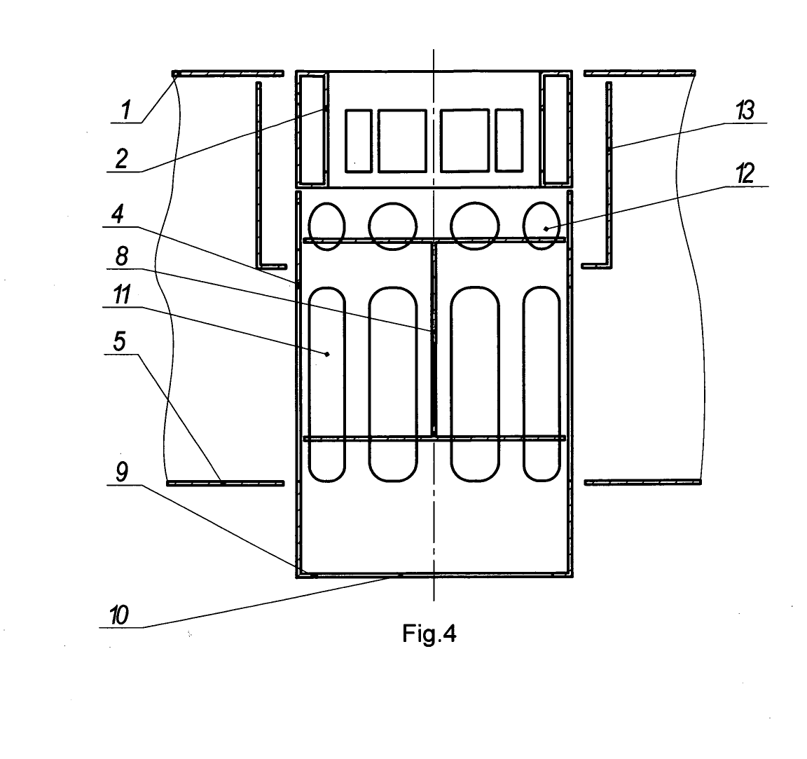

As illustrated on FIGS. 1, 2, 3, and 4, the contact device comprises an upper tray (1), a contact element (2) fixed to the upper tray 1, which contact element 2 includes a bottom opening and a barbotage unit (14) configured as an inner cap with strips (3) tangently bent out; an additional lower tray (5) disposed substantially in a parallel plane below the upper tray 1; a cylindrical casing (4) including a bottom opening (10), a ring-shaped descending limiter (9) formed inside the opening 10, a plurality of vertically extended windows (11) circumferentially disposed on the substantially vertical walls of the casing 4 (lower row) and a plurality of circular orifices (12) circumferentially disposed on the walls of the casing 4 (upper row) above the windows 11; a movable double-acting valve composed of an upper solid plate (6) and a lower solid plate (7) disposed above the plate 6, both the plates are fixedly attached to a distance rod (8) substantially vertically situated; and a cover bushing (13) disposed coaxially to and around the upper region of the casing 4, and embracing the contact element 2.

The contact element 2 also functions as a limiter for lifting the valve i.e. restricting the upward movement of the valve, whereas the bottom edge of the casing 4 functions as a limiter for lowering the valve i.e. restricting the downward movement of the valve, the bottom edges of the windows 11 are disposed at the level of the lower tray 5, and the exterior of the contact element 2 is communicated with the interior of the casing 4 via the inner space of the bushing 13 and via the orifices 12. Optionally, the upper row of orifices and the lower row of windows in the casing can made as continuous holes, i.e. united in one row of openings.

The contact device operates in the following way:

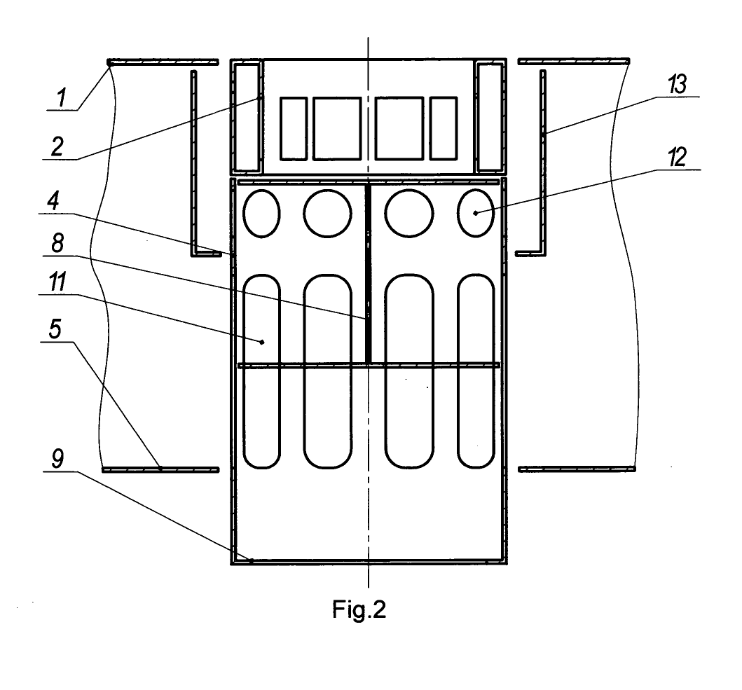

During a ‘steam period’, the gas (steam) phase lifts the movable valve to a predetermined upper position (shown on FIG. 2) in a way that the upper plate closes the bottom opening of the contact element 2. Steam getting under the upper plate 6 through the orifices 12 and the bushing 13 enters the barbotage unit 14 and passes through the liquid layer therein.

At the end of steam period, the valve under the action of its weight and liquid contained therein moves down, reducing the movement speed at the level of the row of orifices 12, and gently descends on the limiter 9. The liquid from the barbotage zone on the tray 1, passes through the windows 11 and gets into the volume limited by the casing 4, the lower tray 5, and the movable valve (transient volume).

The delay time of supplying gas (stem) will be determined by the time of evacuation of liquid from the tray 1 into the transient volume and it will typically take several seconds.

At the initial moment of gas (steam) getting to the bottom plate 7, the lifting force is acting caused by the pressure difference. This force will move the valve upwards together with the liquid contained in the transient volume.

At the moment when the plates reach the level of windows 11, the point of exertion of the lifting force changes from the lower plate 7 to the upper plate 6. At this moment the pressure difference is still maximal, so is the lifting force on the plate 6, since gas (steam) does not pass via the bushing 13 into the space above the plate 6.

Gas (steam) passes however into the windows of the casing 4 due to the process of barbotage. In the course of increasing the active cross-section of the windows, the speed of steam flow is falling that conditions the transfer of liquid into the lower tray 5.

The movable valve continues moving upwards up to a predetermined position. The total weight of the valve and of the liquid above the valve must be less than the lifting force caused by the pressure difference. The time of pouring liquid from one tray to the other is called ‘liquid period’. Thusly, the cycle time, consisting of the gas period and the liquid period, will end at this moment. The following cycles will proceed in an analogous manner.

The proposed mass exchange contact device allows providing the mass-exchange process for a gas (steam)—liquid system in a cyclical mode with at a single change of the liquid delay simultaneously in all trays along the height of column, broadens the operation range of loads with respect to liquid and steam, rises productivity, improves reliability and durability of the device.

The use of the proposed device allows avoiding the intermingling of liquid at the adjacent stages of contact, and permits increasing the efficiency of mass exchange by two or three times relatively to the traditional regular process.

1. A mass exchange contact device comprising:
an upper tray;
a contact element coupled to the upper tray;
a lower tray disposed substantially in a parallel plane below the upper tray;
a cylindrical casing including
a plurality of vertically extended windows circumferentially disposed on the vertical walls of the casing and
a plurality of circular orifices circumferentially disposed on the walls of the casing above the windows;
a movable double-acting valve composed of two solid plates disposed one above the other and fixedly attached to a distance rod situated at the central axe of the valve; and
a cover bushing disposed coaxially around the casing in the upper region thereof; wherein:
said contact element restricts the upward movement of said valve, whereas the bottom edge of said casing restricts the downward movement of said valve, the bottom edges of the windows are disposed at the level of said lower tray, and the exterior of said contact element is communicated with the interior of said casing via the inner space of said bushing and via the orifices.

2. A mass exchange contact device comprising:
an upper tray;
a contact element coupled to the upper tray;
a lower tray disposed below the upper tray;
a cylindrical casing including
hole means;
a movable double-acting valve composed of two solid plates disposed one above the other and fixedly attached to a distance rod; and
a cover bushing disposed coaxially around the casing in the upper region thereof;
wherein:
said contact element restricts the upward movement of said valve, whereas the bottom edge of said casing restricts the downward movement of said valve, and the exterior of said contact element is communicated with the interior of said casing via the inner space of said bushing and via said hole means.
